(19) United States
(12) Patent Application Publication
(10) Pub. No.: US 2016/0182772 A1
(43) Pub. Date: Jun. 23, 2016

(54) CAMERA

(71) Applicants: Fu Tai Hua Industry (Shenzhen) Co., Ltd., Shenzhen (CN); HON HAI PRECISION INDUSTRY CO., LTD., New Taipei (TW)

(72) Inventors: CHAO-FEI LUO, Shenzhen (CN); ZHAN-SHENG LU, Shenzhen (CN)

(21) Appl. No.: 14/659,010

(22) Filed: Mar. 16, 2015

(30) Foreign Application Priority Data
Dec. 18, 2014 (CN) 201410786291.1

(51) Int. Cl. H04N 5/225

(52) U.S. Cl. CPC H04N 5/2252; H04N 5/2254

(57) ABSTRACT

A camera includes a main body, a positioning member fixedly fitted about the main body, and a latching member. The main body includes a camera lens. The camera lens extends through the positioning member and is exposed out of the positioning member. The positioning member evenly defines four grooves surrounding the camera lens. Each groove includes two inclined surfaces. The latching member includes a main plate with a through hole aligned with the camera lens. Four catching portions extend down from the main plate surrounding the through hole, and the catching portions are respectively received in the corresponding grooves of the positioning member. Each catching portion includes two inclined walls affixed to the two inclined surfaces respectively.

### FIELD

The subject matter herein generally relates to an electronic device with a camera.

### BACKGROUND

Electronic devices, such as mobile phones, are generally equipped with cameras. The camera is usually mounted in the electronic device, in alignment with a camera area of a panel of the electronic device.

### BRIEF DESCRIPTION OF THE DRAWINGS

Implementations of the present technology will now be described, by way of example only, with reference to the attached figures.

FIG. 1 is an exploded, isometric view of an embodiment of an electronic device, wherein the electronic device comprises an enclosure, a camera, and a panel.

FIG. 2 is exploded, isometric view of the camera of FIG. 1.

FIG. 3 is similar to FIG. 2, but viewed from another angle.

FIG. 4 is an assembled, isometric view of the camera of FIG. 2.

FIG. 5 is an assembled, isometric view of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series and the like.

The present disclosure is described in relation to an electronic device with a camera.

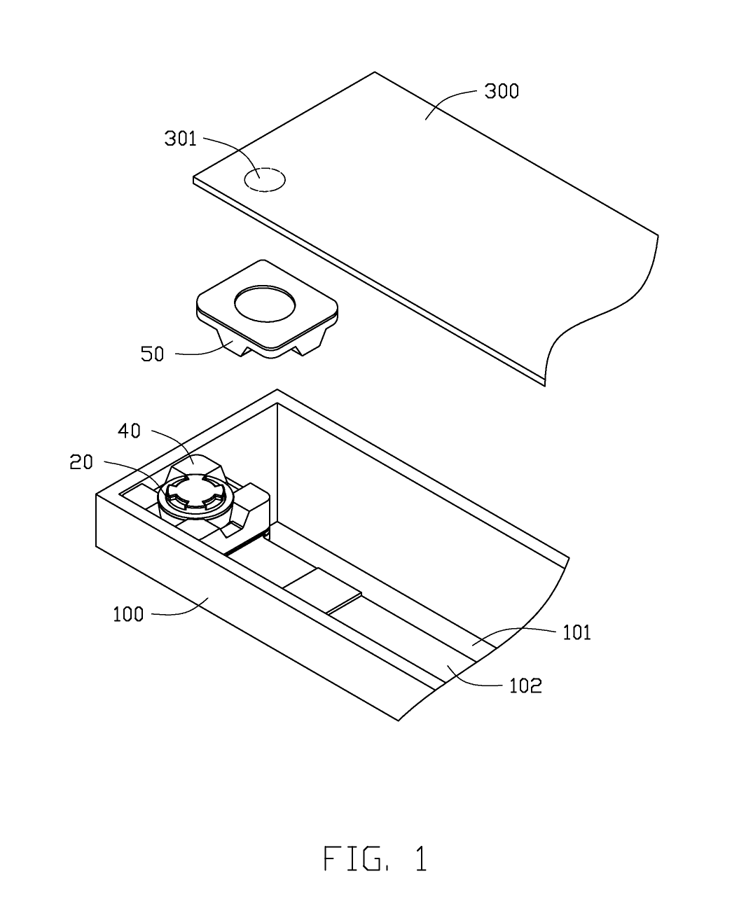

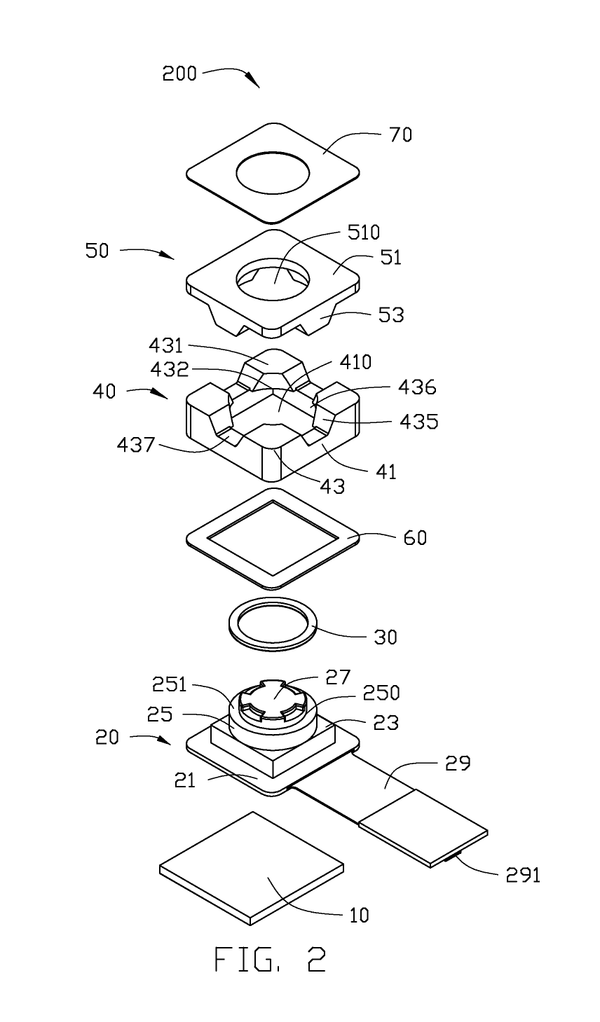

FIG. 1 and FIG. 2 illustrate an exemplary embodiment of an electronic device. The electronic device comprises an enclosure 100, a camera 200 and a rectangular panel 300. The enclosure 100 comprises a back plate 101, and a motherboard 102 received in the enclosure 100 and fixed to the back plate 101. The panel 300 comprises a camera area 301. In the embodiment, the electronic device is a mobile phone. In another embodiment, the electronic device can be a portable computer or a notebook computer.

The camera 200 comprises a supporting pad 10, a main body 20, a dust-resistant ring 30, a positioning member 40, and a latching member 50. A top surface and a bottom surface of the supporting pad 10 are positioned with adhesives.

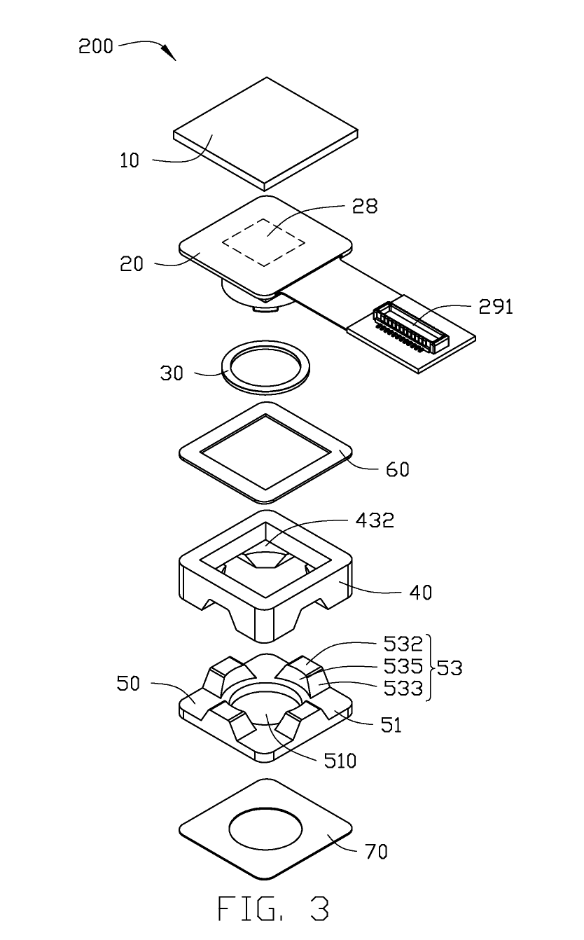

The main body 20 comprises a bottom plate 21, a rectangular base 23 fixed to a top surface of the bottom plate 21, a cylindrical table 25 formed on a top surface of the base 23, a camera lens 27 and a circuit board 29 attached to the bottom plate 21. A mounting hole 250 is defined in a middle portion of the cylindrical table 25, extending through the base 23 and the bottom plate 21. The camera lens 27 and an optical sensor 28 (see FIG. 3) are received in the mounting hole 250. A top of the camera lens 27 is exposed from a top of the cylindrical table 25. The optical sensor 28 is mounted to the circuit board 29 and aligned with the camera lens 27. A connector 291 is coupled to a side of the circuit board 29 away from the bottom plate 21. The cylindrical table 25 comprises an annular supporting surface 251 formed at an end away from the base 23 and surrounding the camera lens 27.

The positioning member 40 comprises a rectangular positioning plate 41. A through hole 410 is defined in a center of the positioning plate 41 for receiving the base 23. Four blocks 43 respectively extend from four corners of the positioning plate 41. Inside surfaces of the four blocks 43 are extending to four corners of the through hole 410. Each block 43 comprises a top surface 431, a bottom surface 432, two inclined surfaces 435 extending slantwise from opposite sides of the top surface 431 toward the two adjacent blocks 43 and a connecting surface 436 coupled to the two inclined surfaces 435 toward the through hole 410. Each two adjacent inclined surfaces 435 of the adjacent blocks 43 and the positioning plate 41 forms a groove 437 with an isosceles trapezoidal cross section. A top of each groove 437 is wider than a bottom of the groove 437. The connecting surface 436 of each block 43 is an arced surface. An angle between each inclined surface 435 and a bottom surface of the corresponding groove 437 is in a range of 90-180 degrees. In the embodiment, the angle is 120 degrees. In another embodiment, the cross section of the grooves 437 can be semicircular.

FIG. 3 illustrates the latching member 50. The latching member 50 comprises a rectangular main plate 51 and four catching portions 53 each with trapezoidal cross section extending down from the main plate 51. A top of each catching portion 53 is wider than a bottom of each catching portion 53. A through hole 510 is defined in the main plate 51. The four catching portions 53 are respectively formed at middles of the four side surfaces of the main plate 51 and surrounding the through hole 510. Each catching portion 53 comprises a bottom wall 532 parallel to the main plate 51, two inclined walls 533 slantingly extending from opposite sides of the bottom wall 532 to a bottom surface of the main plate 51, and a connecting wall 535 extending from a side of the bottom wall 352 to the main plate 15 and coupled to the two adjacent inclined walls 533. The connecting wall 535 of each catching portion 35 is an arced surface. An angle between each inclined wall 533 and a bottom wall 532 is in a range of 90-180 degrees. In the embodiment, the angle is 120 degrees.

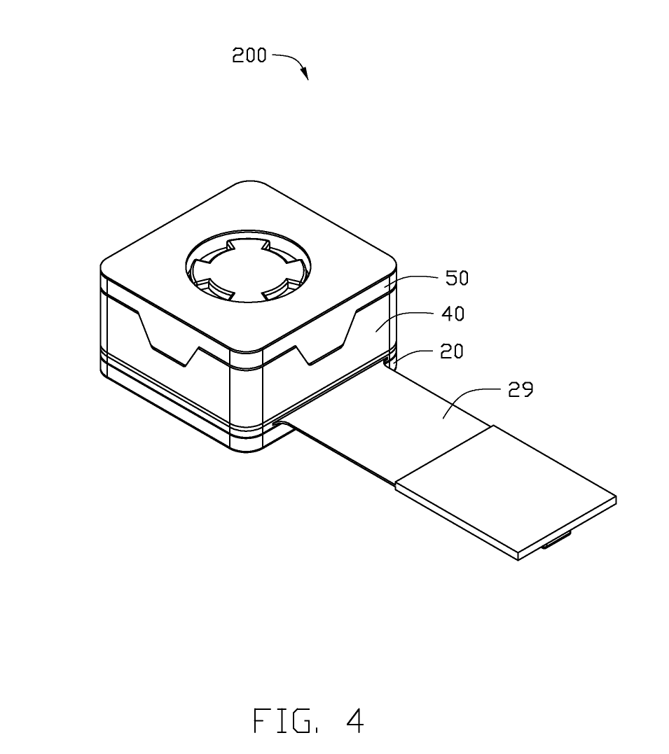

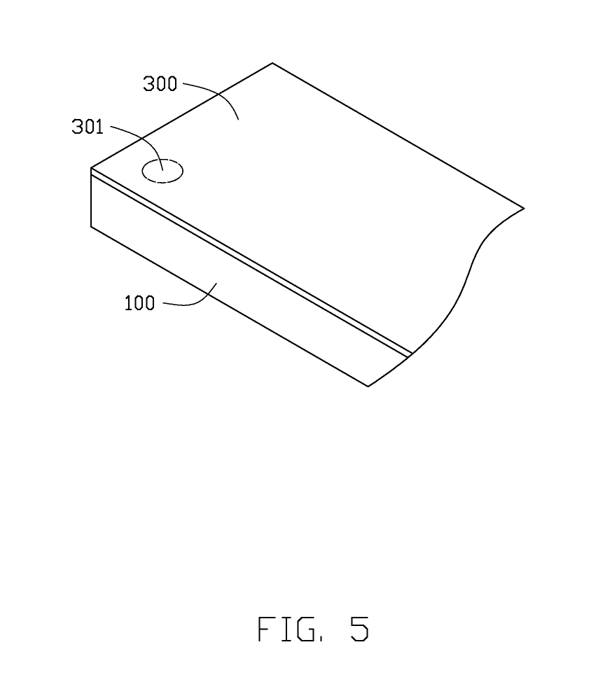

FIG. 4 and FIG. 5 illustrate the assembly of the camera 200 and the electronic device. The dust-resistant ring 30 is placed around the camera lens 27 of the main body 20 and supported on the supporting surface 251 of the cylindrical table 25. Then, a first double-sided adhesive frame 60 with a rectangular slot is placed around the outside of the base 23 and affixed to the bottom plate 21. The positioning plate 41 of the positioning member 40 is fixed to the first double-sided adhesive frame 60, the base 23 is engaged with the through hole 410 of the positioning member 40. The four connecting surfaces 436 abut against the cylindrical table 25. The top surface of the supporting pad 10 is affixed to a bottom surface of the bottom plate 21. The main body 20 is mounted to the enclosure 100, the bottom surface of the supporting pad 10 is affixed to the backboard 101 at a predetermined angle, and an outside surface of the positioning plate 41 is parallel to a sidewall of the enclosure 100. The connector 291 of the main body 20 is connected with the motherboard 102 of the enclosure 100.

A second double-sided adhesive frame 70 with a circular slot is affixed to the top of the main plate 51; the latching member 50 is placed below the panel 300. The through hole 510 of the latching member 50 is aligned with the camera area 301 of the panel 300 via optical projection; a top wall of the main plate 51 is parallel to the panel 300. The latching member 50 is precisely fixed to the panel 300 by affixing the second double-sided adhesive frame 70 to the panel 300 at a predetermined angle.

The panel 300 is placed above the enclosure 300, the four blocks 53 of the latching member 50 are respectively aligned with the four grooves 437 of the positioning member 40. The panel 300 is attached to a top of the enclosure 300, the four latching portions 53 are respectively inserted into the four grooves 437, and the bottom surface of the main plate 51 is supported on the dust-resistant ring 30. When a center of the camera lens 27 deviates from a center of the camera area 301, at least one inclined walls 533 can drive the corresponding inclined surface 435 to move the main body 20 and the supporting pad 10 is elastically deformed. The four connecting walls 535 abut against an outside of the cylindrical table 25. The camera lens 27 is thereby precisely aligned with the camera area 301 again.

The embodiments shown and described above are only examples. Many details are often found in the art such as the other features of a camera. Therefore, many such details are neither shown nor described. Even though numerous characteristics and advantages of the present technology have been set forth in the foregoing description, together with details of the structure and function of the present disclosure, the disclosure is illustrative only, and changes may be made in the details, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A camera comprising:
a main body comprising a camera lens;
a positioning member placed around the main body and comprising a plurality of grooves surrounding the camera lens; and
a latching member comprising a main plate, a first through hole aligning with the camera lens, and a plurality of catching portions formed on the main plate and respectively received in the grooves of the positioning member;
wherein each groove comprises two opposite inclined surfaces, each latching portion comprises two inclined walls respectively abutting against the two inclined surfaces, a top of each groove is wider than a bottom of each groove, a top of each latching portion is wider than a bottom of each latching portion.

2. The camera of claim 1, wherein cross sections of the latching members and the grooves are isosceles trapezoidal or semicircular.

3. The camera of claim 1, wherein the main body comprises a bottom plate, a base formed on a top surface of the bottom plate, and a cylindrical table formed on a top surface of the base, the camera lens is received in the cylindrical table and exposing out of the top of the cylindrical table.

4. The camera of claim 3, wherein the positioning member comprises a positioning plate, the positioning plate defines a second through hole for receiving the base, a plurality of blocks surround the second through hole extends from the positioning plate, inner surfaces of the blocks extend to a top of the second through hole, each groove is defined between two adjacent blocks, each catching portion comprises a connecting wall connected between to the two inclined walls and abutting against the cylindrical table, each block comprises a connecting surface coupled between the two inclined surfaces and abutting against the cylindrical table.

5. The camera of claim 4, wherein the positioning plate is rectangular, four blocks respectively extend from four corners of the positioning plate, each groove is defined between two adjacent blocks.

6. The camera of claim 1, wherein the main plate is rectangular, four catching portions are respectively formed on four sides of the main plate.

7. A camera comprising:
a main body having a camera lens;
a positioning member positioned around the main body and having a plurality of defined grooves surrounding the camera lens; and
a latching member having a main plate, a first through hole aligned with the camera lens and a plurality of latching portions formed on a first side of the main plate and received into the plurality of positioning member defined grooves;
wherein, each positioning member defined groove has a first inclined surface and an opposite second inclined surface forming a groove opening and sloping inward to a groove bottom, with the groove opening being larger than the groove bottom;
wherein, each latching portion has a first inclined wall, an opposite second inclined wall and a bottom surface, with the first inclined wall sloping toward the second inclined wall from the latching member main plate to the bottom surface forming a latching member wider at the main plate than the bottom surface; and
wherein, the first inclined walls and the second inclined walls of the latching portions abut against the first inclined surfaces and the second inclined surfaces of the defined grooves.

8. The camera of claim 7, wherein cross sections of the latching members and the grooves are isosceles trapezoidal or semicircular.

9. The camera of claim 7, wherein the main body comprises a bottom plate, a base formed on a top surface of the bottom plate, and a cylindrical table formed on a top surface of the base, the camera lens is received in the cylindrical table and exposing out of the top of the cylindrical table.

10. The camera of claim 9, wherein the positioning member comprises a positioning plate, the positioning plate defines a second through hole for receiving the base, a plurality of blocks surround the second through hole extends from the positioning plate, inner surfaces of the blocks extend to a top of the second through hole, each groove is defined between two adjacent blocks, each catching portion comprises a connecting wall connected between to the two inclined walls and abutting against the cylindrical table, each block comprises a connecting surface coupled between the two inclined surfaces and abutting against the cylindrical table.

11. The camera of claim 10, wherein the positioning plate is rectangular, four blocks respectively extend from four corners of the positioning plate, each groove is defined between two adjacent blocks.

12. The camera of claim 11, wherein the main plate is rectangular, four catching portions are respectively formed on four sides of the main plate

13. An electronic device comprising:
an enclosure;
a panel fixed to a top of the enclosure and comprising a camera area;
a camera mounted between the enclosure and the panel; and
an elastic supporting pad mounted to the enclosure;
the camera comprising:
a main body fixed to the supporting pad and comprising a camera lens;
a positioning member placed around the main body and comprising four grooves surrounding the camera lens; and
a latching member comprising a main plate fixed to the panel, a first through hole aligning with the camera lens and the camera area, and four catching portions formed on the main plate and respectively received in the four grooves of the positioning member;
wherein, each positioning member defined groove has a first inclined surface and an opposite second inclined surface forming a groove opening and sloping inward to a groove bottom, with the groove opening being larger than the groove bottom;
wherein, each latching portion has a first inclined wall, an opposite second inclined wall and a bottom surface, with the first inclined wall sloping toward the second inclined wall from the latching member main plate to the bottom surface forming a latching member wider at the main plate than the bottom surface; and
wherein, the first inclined walls and the second inclined walls of the latching portions abut against the first inclined surfaces and the second inclined surfaces of the defined grooves.

14. The electronic device of claim 13, wherein cross sections of the latching members and the grooves are isosceles trapezoidal or semicircular.

15. The electronic device of claim 14, wherein the main body comprises a bottom plate, a base formed on a top surface of the bottom plate, and a cylindrical table formed on a top surface of the base, the camera lens is received in the cylindrical table and exposing out of the top of the cylindrical table.

16. The electronic device of claim 15, wherein the positioning member comprises a positioning plate, the positioning plate defines a second through hole for receiving the base, four blocks surrounding the second through hole extend from the positioning member, inner surfaces of the four blocks extend to a top of the through slot, each groove is defined between two adjacent blocks , each catching portion comprises a connecting wall coupled to the two inclined walls and abutting against the cylindrical table, each block comprises a connecting surface coupled to the two inclined surfaces and abutting against the cylindrical table.

17. The electronic device of claim 16, wherein the positioning plate is rectangular, the four blocks are respectively extending from four corners of the positioning plate, the four grooves are formed on four sides of the positioning member.

18. The electronic device of claim 13, wherein the main plate is rectangular, the four catching portions are formed on four sides of the main plate.
